(19) United States
(12) Patent Application Publication
(10) Pub. No.: US 2011/0283122 A1
(43) Pub. Date: Nov. 17, 2011

(54) WIRELESS COMMUNICATION DEVICE AND METHOD FOR CONTROLLING WIRELESS COMMUNICATION DEVICE

(75) Inventors: Tomoaki Ohara, Nagoya-shi (JP); Hainian Song, Nagoya-shi (JP); Daisuke Yamada, Nagoya-shi (JP)

(73) Assignee: BUFFALO INC., Nagoya-shi (JP)

(21) Appl. No.: 13/106,877

(22) Filed: May 13, 2011

(30) Foreign Application Priority Data
May 13, 2010 (JP) 2010-111139

(51) Int. Cl. G06F 1/28

(52) U.S. Cl. 713/310

(57) ABSTRACT

The wireless communication device includes a main body, and an accessory device connectable to the main body. The accessory device includes a power supply interface configured to supply power to the main body when the accessory device is connected to the main body. The main body includes a wireless communication interface and a secondary battery. A determination section determines whether a predetermined condition in which the main body is connected to and supplied with power from the accessory device, is satisfied. A wireless output power level determination section determines a low power level value to be used as a wireless output power level of the wireless communication interface. A wireless output control section sets the wireless output power level to a predetermined standard power level value when the predetermined condition is satisfied, and to the low power level value when the predetermined condition is not satisfied.

### CROSS REFERENCE TO RELATED APPLICATION

The disclosure of Japanese Patent Application No. 2010-111139, filed on May 13, 2010, is incorporated herein by reference.

### BACKGROUND OF THE INVENTION

1. Field of the Invention

The present invention relates to a wireless communication device performing wireless communication in a wireless communication network.

2. Description of the Background Art

Access points as wireless communication devices are widely utilized in homes and offices to connect stations such as personal computers and game machines in a wired or wireless LAN (Local Area Network) to another network (refer to Japanese Laid-Open Patent Publication No. 2005-142907, for example). Hereinafter, a non-access point station, which performs, as a client, wired or wireless communication with an access point, is referred to simply as a station.

The conventional access point may be disadvantageous in that it may not be compliant with a plurality of communication networks; it may not be compliant with both wireless communication and wired communication; and the life of a secondary battery embedded therein may be short. Therefore, when such an access point, which is ordinarily used in the home or office as a station for network connection, is used outside the home or office, the access point cannot establish a connection with another station or the like in accordance with a network mode at the outside location, or the access point cannot be used for a long period of time if an external power supply is not available, resulting in inconvenience to the user.

The above-described deficiencies are not limited to wireless communication devices serving as access points but are common to general wireless communication devices performing wireless communications in wireless communication networks.

### SUMMARY OF THE INVENTION

An object of the present invention is to provide a wireless communication device which can provide desired connections with other stations or the like in accordance with a variety of network modes, and which can be used for a long period of time even when an external power supply is not available.

A first aspect of the present invention is directed to a wireless communication device for use in a communication network, including a main body, and an accessory device connectable to the main body. The accessory device includes: a power supply interface configured to supply power to the main body when the accessory device is connected to the main body. The main body includes: one or more wireless communication interfaces configured to perform wireless communication; a secondary battery for supplying power to the main body at least when the main body is not connected to the accessory device; a determination section configured to determine whether a predetermined condition is satisfied, the predetermined condition including at least that the main body is connected to the accessory device and supplied with power from the accessory device; a wireless output power level determination section configured to determine one or more low power level values to be used as the respective wireless output power levels of the one or more wireless communication interfaces; and a wireless output control section configured to set the wireless output power levels of the one or more wireless communication interfaces to predetermined standard power level values when the predetermined condition is satisfied, and set the wireless output power levels of the one or more wireless communication interfaces to the respective one or more low power level values determined by the wireless output power level determination section, which low power level values are smaller than the predetermined standard power level values, when the predetermined condition is not satisfied.

Preferably, the accessory device further includes: a port for connecting the accessory device to a network cable; and a selector switch configured to switch the port between a state where the port functions as a port for the Internet and a state where the port functions as a port for a local network. The predetermined condition includes that the port is in the state where it functions as a port for the Internet, and data transfer is carried out via the port.

Preferably, the accessory device further includes: a port for connecting the accessory device to a network cable; and a selector switch configured to switch the port between a state where the port functions as a port for the Internet and a state where the port functions as a port for a local network. The predetermined condition includes that the port is in the state where it functions as a port for the Internet, and a network cable is connected to the port so that a link is established between the port and a destination device via the network cable.

Preferably, the wireless output power level determination section is configured to determine, for each of at least one wireless communication interface of the one or more wireless communication interfaces, the one or more low power level values in such a manner that the greater the wireless input power level of the wireless communication interface is, the smaller is the low power level value to be used as the wireless output power level of the wireless communication interface.

Preferably, the main body includes a plurality of the wireless communication interfaces performing wireless communications in different wireless communication networks.

A second aspect of the present invention is directed to a wireless communication device for use in a communication network, including one or more wireless communication interfaces for use in a communication network; a secondary battery for supplying the wireless communication device with power at least when the wireless communication device is not supplied with power from outside; a determination section configured to determine whether a predetermined condition is satisfied, the predetermined condition including at least that the main body is supplied with power from outside; a wireless output power level determination section configured to determine one or more low power level values to be used as the respective wireless output power levels of the one or more wireless communication interfaces; and a wireless output control section configured to set the wireless output power levels of the one or more wireless communication interfaces to predetermined standard power level values when the predetermined condition is satisfied, and set the wireless output power levels of the one or more wireless communication interfaces to the respective one or more low power level values determined by the wireless output power level determination section, which low power level values are smaller than the predetermined standard power level values, when the predetermined condition is not satisfied.

The present invention may be embodied in various forms. For example, the present invention may be embodied as a wireless communication device, a wireless communication system including a wireless communication device, a method for controlling the device or system, a computer program for realizing functions of the method, device, or system, and a recording medium storing the computer program.

The present invention is applicable to, for example, a communication device performing communication including wireless communication in a communication network. These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram illustrating a front view and a rear view of a wireless communication device according to an embodiment of the present invention;

FIG. 2 is a diagram illustrating side views of the wireless communication device according to the embodiment of the present invention;

FIG. 3 is a diagram illustrating top views of the wireless communication device and a cradle according to the embodiment of the present invention;

FIG. 4 is a block diagram illustrating the configuration of the wireless communication device according to the embodiment of the present invention;

FIG. 5 is a diagram illustrating connection modes of the wireless communication device according to the embodiment of the present invention;

FIG. 6 is a diagram illustrating a connection mode of the wireless communication device according to the embodiment of the present invention; and

FIG. 7 is a flowchart illustrating a wireless output control process performed by the wireless communication device according to the embodiment of the present invention.

### DESCRIPTION OF THE PREFERRED EMBODIMENTS

Hereinafter, preferred embodiments of the present invention will be described.

### Embodiment 1

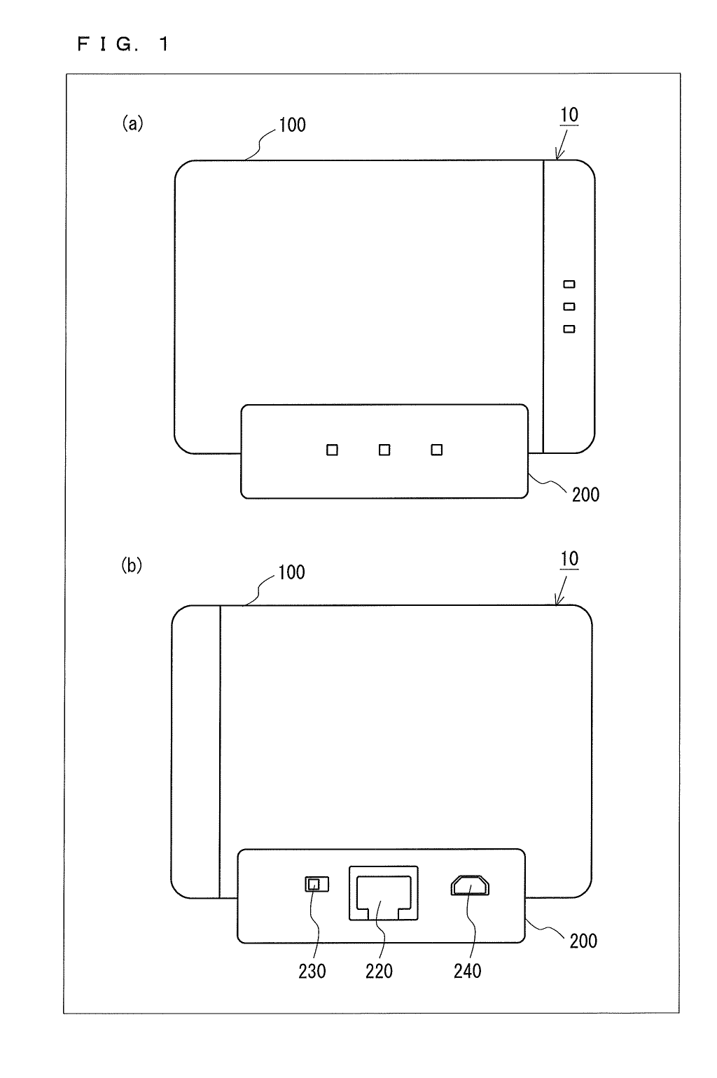

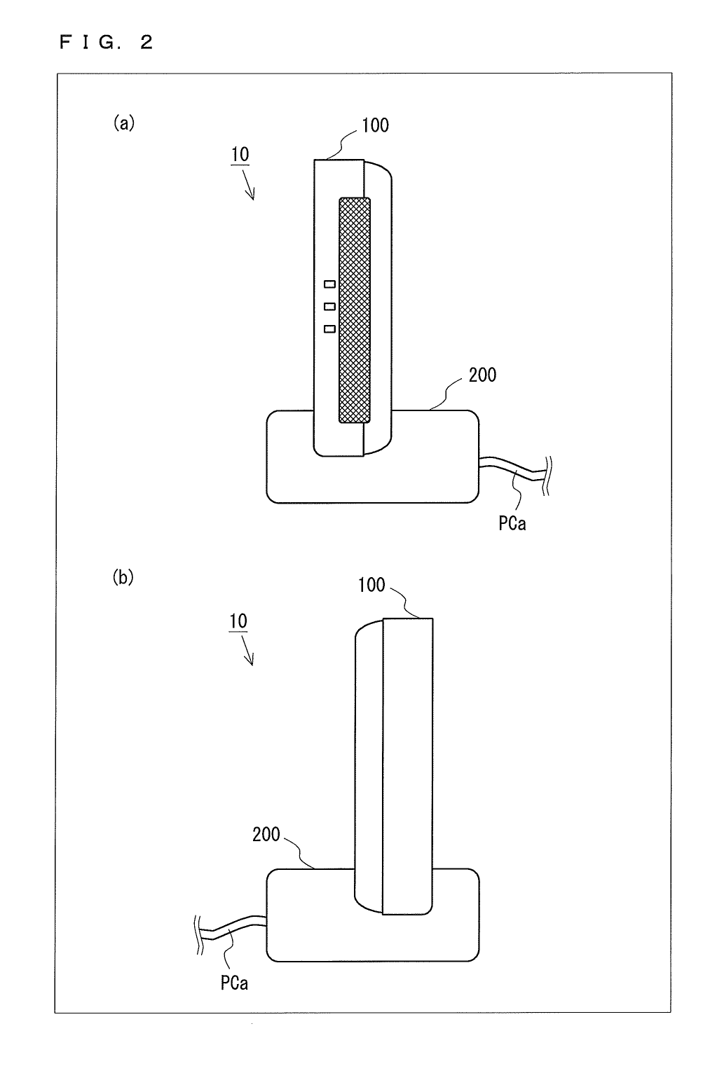

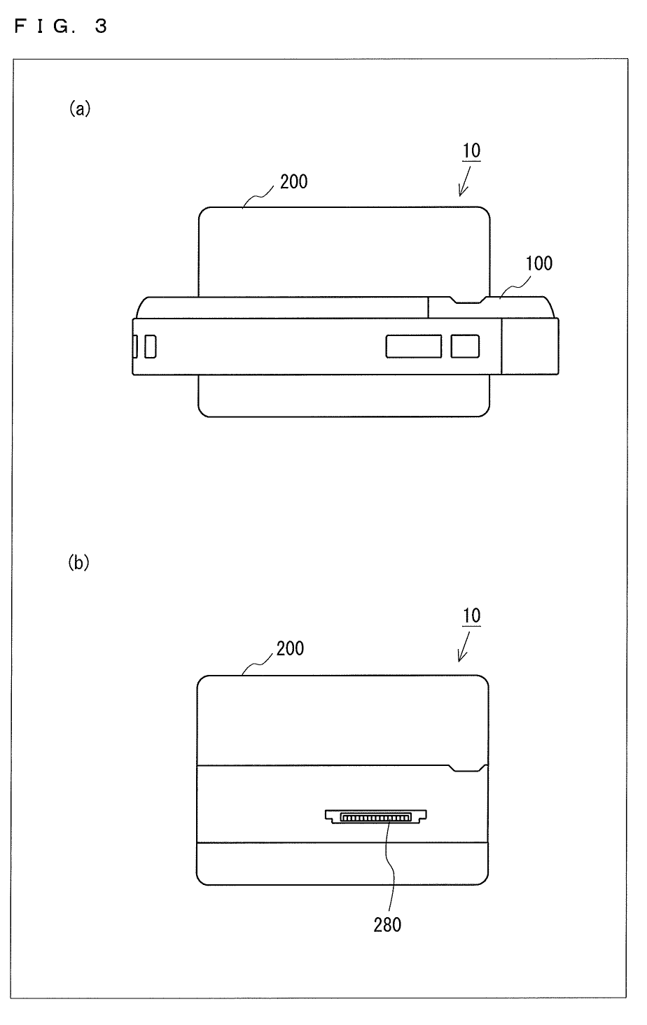

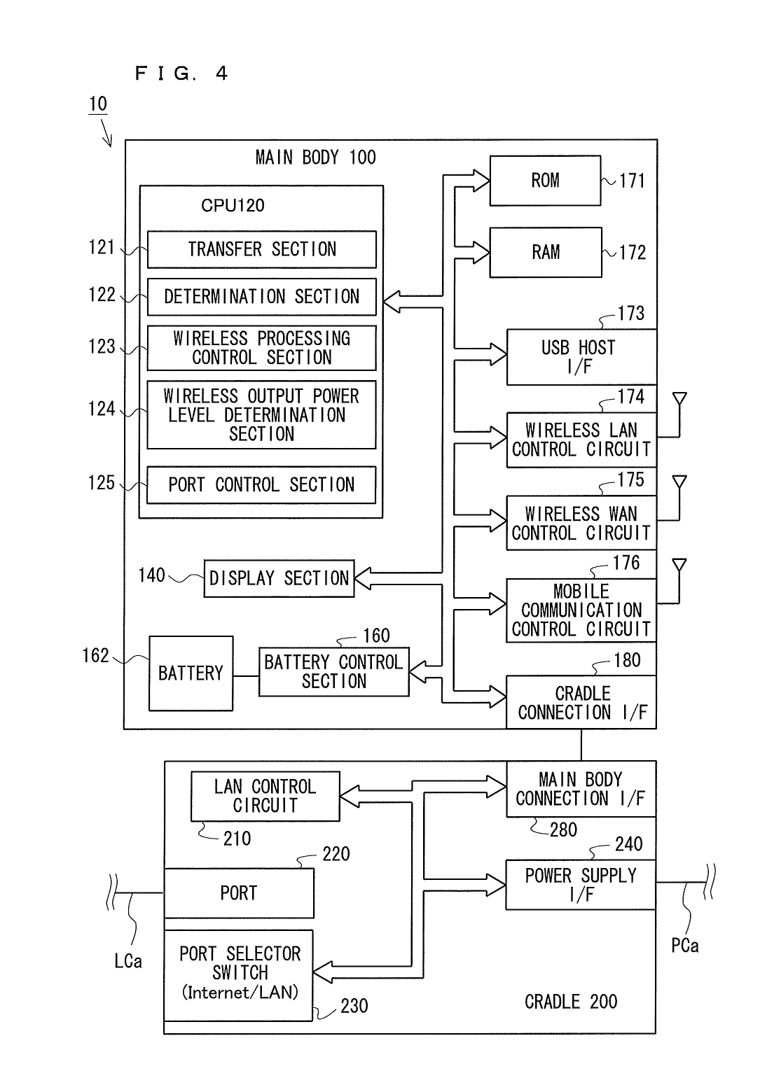

The following will describe a configuration of a wireless communication device 10 according to Embodiment 1 of the present invention. FIGS. 1 to 4 are schematic diagrams illustrating the configuration of the wireless communication device 10. In FIG. 1, (a) and (b) show a front view and a rear view of the wireless communication device 10, respectively. In FIG. 2, (a) and (b) show one side view and the other side view of the wireless communication device 10, respectively. In FIG. 3, (a) shows a top view of the wireless communication device 10, and (b) shows a top view of a cradle included in the wireless communication device 10. FIG. 4 is a functional block diagram of the wireless communication device 10.

The wireless communication device 10 includes a main body 100 and a cradle 200 as an attached component, which are mutually connectable (disconnectable). The main body 100 is a compact and light-weight mobile unit, and solely has a wireless communication function. The cradle 200 provides the main body 100 with various kinds of functions when it is connected to the main body 100. In this embodiment, the cradle 200 also serves as a stand for holding the main body 100.

As shown in (b) of FIG. 1, (b) of FIG. 3, and FIG. 4, the cradle 200 includes: a LAN port 220 compliant with, for example, the IEEE 802.3/3u standard; a port selector switch 230 for changing the function of the LAN port 220; a power supply interface (I/F) 240 for connecting a power supply cable PCa to the cradle 200; a main body connection interface (I/F) 280 for connecting the cradle 200 to the main body 100; and a LAN control circuit 210 which is compliant with a predetermined network protocol (the Ethernet (trademark), for example) and controls data transmission via the LAN port 220. The cradle 200 may have a variety of indicators indicating the operating states of the wireless communication device 10.

The port selector switch 230 is switchable between an “Internet” state and a “LAN” state. In the state where the port selector switch 230 is switched to the “Internet” state, the LAN port 220 functions as a port for the Internet (or other external network) under control of a port control section 125 to be described later. In the state where the port selector switch 230 is switched to the “LAN” state, the LAN port 220 functions as a port for the local network (for the LAN or the internal network) under control of the port control section 125.

The main body connection interface 280 has a function of, for example, a USB device controller. When the cradle 200 is connected to the main body 100, the main body connection interface 280 is compliant with the USB standard, and communicates with the main body 100 to transmit and/or receive data such as communication data and a variety of control data. When the cradle 200 is connected to the main body 100, the power supply interface 240 supplies the main body 100 with power from the power supply cable PCa via the main body connection interface 280.

As shown in FIG. 4, the main body 100 of this embodiment includes: a CPU 120 as a processor; a display section 140 for displaying the operating state of the wireless communication device 10 by using an indicator or the like; a battery 162 as a secondary battery; a battery control section 160 for controlling charging/discharging of the battery 162; a ROM 171; a RAM 172; a USB host interface (IF) 173 for connecting a USB device to the main body 100; a wireless LAN control circuit 174; a wireless WAN control circuit 175; a mobile communication control circuit 176; and a cradle connection interface (I/F) 180 for connecting the cradle 200 to the main body 100.

The battery 162 is charged with power supplied from the cradle 200, under control of the battery control section 160, when the main body 100 is connected to the cradle 200. Further, the battery 162 supplies, by discharging, power for operating the main body 100, when the main body 100 is not connected to the cradle 200. Even when the main body 100 is connected to the cradle 200, if no power is supplied from the cradle 200 to the main body 100 due to, for example, disconnection of the power supply cable PCa, the battery 162 supplies, by discharging, power for operation of the main body 100.

The wireless LAN control circuit 174 includes a modulator, an amplifier, and an antenna. The wireless LAN control circuit 174 performs, as an interface of an access point function in a wireless LAN compliant with, for example, the IEEE 802.11(a/b/g/n) standard, wireless communication with a station (for example, a personal computer or a game machine) as a client in the wireless LAN. Likewise, the wireless WAN control circuit 175 includes a modulator, an amplifier, and an antenna. The wireless WAN control circuit 175 performs, as an interface of a station that is a client in a wireless LAN compliant with, for example, the IEEE 802.11(a/b/g/n) standard, wireless communication with an access point in a WAN (Wide Area Network), for example, a public wireless LAN. Likewise, the mobile communication control circuit 176 includes a modulator, an amplifier, and an antenna. The mobile communication control circuit 176 performs, as an interface of user equipment for mobile communication compliant with, for example, the 3G/HSPA standard, wireless communication with a base station in a mobile communication network. In this way, the main body 100 of the present embodiment can perform wireless communication in different wireless communication networks. The wireless LAN control circuit 174, the wireless WAN control circuit 175, and the mobile communication control circuit 176 provide a plurality of wireless communication interfaces compliant with the respective standards.

The cradle connection interface 180 has a function of a USB host controller. When the main body 100 is connected to the cradle 200, the cradle connection interface 180 performs, based on the USB standard, communication of data with the cradle 200. When the main body 100 is connected to the cradle 200, the cradle connection interface 180 transfers power supplied from the cradle 200, via the main body connection interface 280, to the battery control section 160.

The CPU 120 loads, into the RAM 172, firmware or computer programs stored in the ROM 171, and executes the firmware or programs to control the components of the wireless communication device 10. The CPU 120 functions as a transfer section 121, a determination section 122, a wireless output control section 123, a wireless output power level determination section 124, and the port control section 125. The transfer section 121 controls the wireless communication interfaces (the wireless LAN control circuit 174, the wireless WAN control circuit 175, and the mobile communication control circuit 176) to perform data transfer between the wireless communication device 10 and a communication destination. The functions of the determination section 122, the wireless output control section 123, and the wireless output power level determination section 124 will be described later in detail.

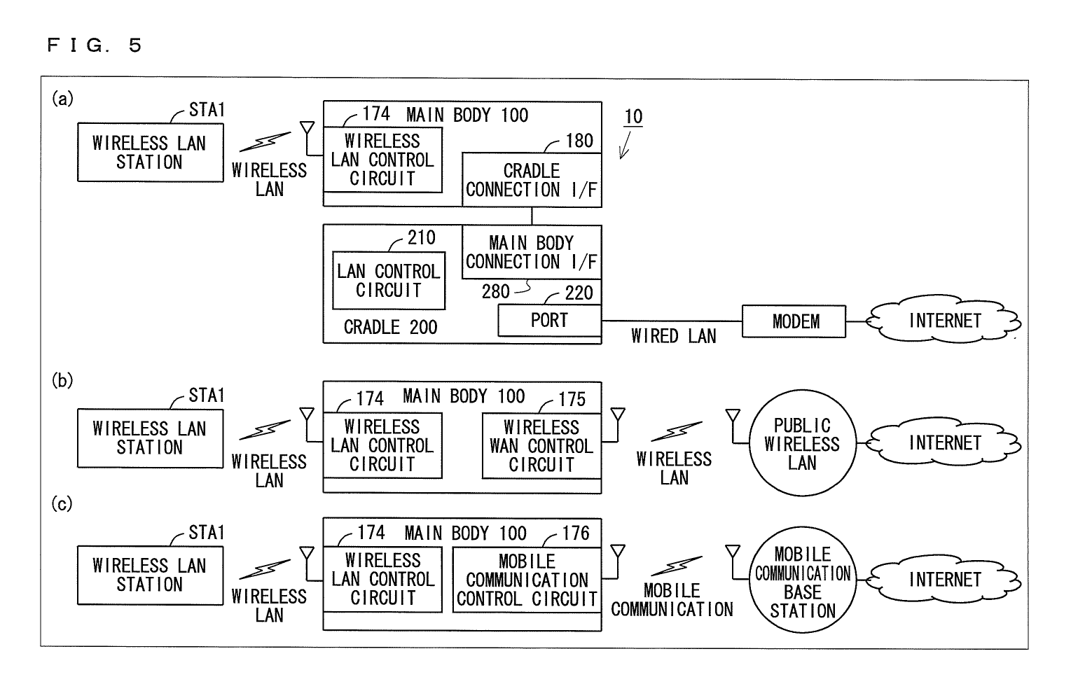

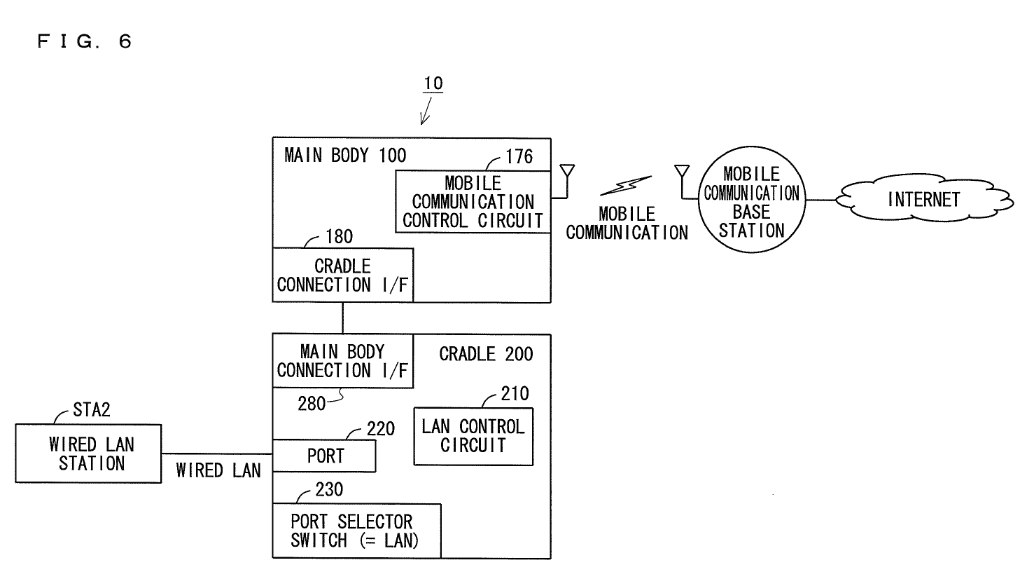

The wireless communication device 10 of the present embodiment can perform wireless communication in a variety of connection modes. FIGS. 5 and 6 are diagrams illustrating examples of connection modes for wireless communication by the wireless communication device 10 of the present embodiment. In the first connection mode, illustrated by way of example in (a) of FIG. 5, the main body 100 is connected to the cradle 200. One end of a LAN cable (network cable), whose other end is connected to, for example, a FTTH modem or a DSL modem, is connected to the LAN port 220 of the cradle 200. When the port selector switch 230 is switched to the “Internet” state, the wireless communication device 10 serves as an access point for a station STA1 which is a client in the wireless LAN, and performs wireless communication with the station STA1 via the wireless LAN control circuit 174. In this connection mode, the station STA1 is accessible to the Internet via the wireless communication device 10 and the modem.

In the second connection mode, illustrated by way of example in (b) of FIG. 5, the main body 100 is not connected to the cradle 200. The wireless communication device 10 serves as an access point for the station STA1 in the wireless LAN, and performs wireless communication with the station STA1 via the wireless LAN control circuit 174. Further, the wireless communication device 10 serves as a client in a public wireless LAN, and performs wireless communication with the public wireless LAN via the wireless WAN control circuit 175. In this connection mode, the station STA1 is accessible to the Internet via the wireless communication device 10 and the public wireless LAN.

In the third connection mode, illustrated by way of example in (c) of FIG. 5, the main body 100 is not connected to the cradle 200. The wireless communication device 10 serves as user equipment for a mobile communication base station, and performs wireless communication with the mobile communication base station via the mobile communication control circuit 176. In this connection mode, the station STA1 is accessible to the Internet via the wireless communication device 10 and the mobile communication base station.

In the fourth connection mode, illustrated by way of example in FIG. 6, the main body 100 is connected to the cradle 200. One end of a LAN cable, whose other end is connected to a station STA2 in a wired LAN, is connected to the LAN port 220 of the cradle 200. When the port selector switch 230 is switched to the “LAN” state, the wireless communication device 10 serves as user equipment for a mobile communication base station, and performs wireless communication with the mobile communication base station via the mobile communication control circuit 176. In this connection mode, the station STA2 is accessible to the Internet via the wireless communication device 10 and the mobile communication base station. In this connection mode, the wireless communication device 10 may alternatively serve as a client in a public wireless LAN to perform wireless communication with the public wireless LAN via the wireless WAN control circuit 175, instead of serving as user equipment for the mobile communication base station to perform wireless communication with the mobile communication base station via the mobile communication control circuit 176.

As shown in FIGS. 5 and 6, the wireless communication device 10 of the present embodiment can perform wireless communication with a station STA1, in a state where the wireless communication device 10 is wire-connected to a modem in the home or office. Further, the wireless communication device 10 can perform wireless communication with a station STA1, in a state where the wireless communication device 10, located outside the home or office, is wirelessly connected to a public wireless LAN or a mobile communication base station. Moreover, the wireless communication device 10 can perform wired communication with a station STA2, in a state where the wireless communication device 10 is wirelessly connected to a public wireless LAN or a mobile communication base station in the home or office. That is, the wireless communication device 10 can perform wireless communication in a variety of connection modes, thereby enhancing the user's convenience.

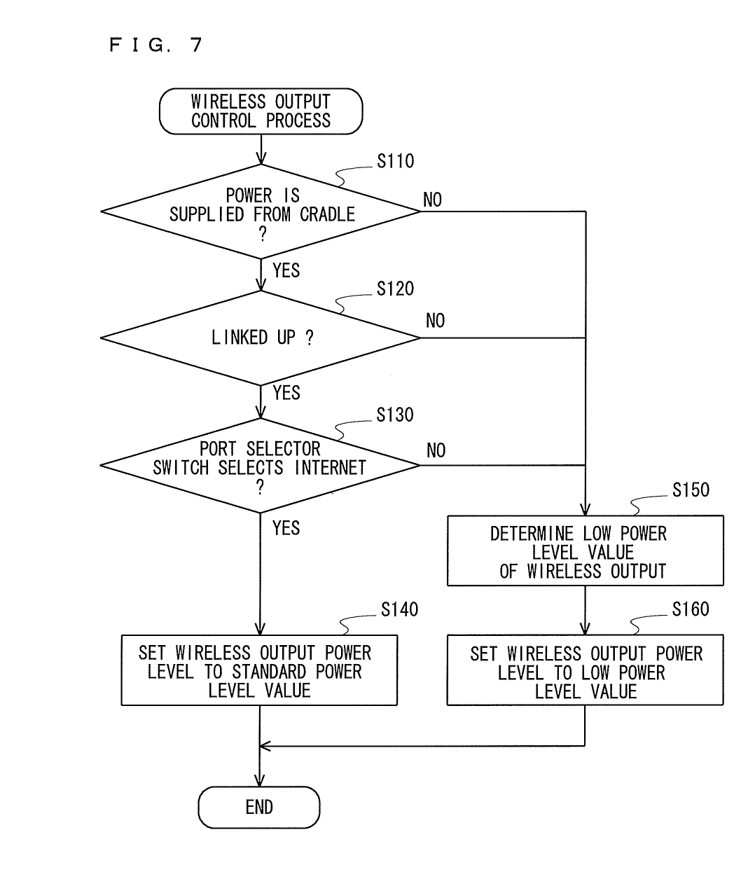

The following describes a wireless output control process according to an embodiment of the invention, performed by the wireless communication device 10. FIG. 7 is a flowchart illustrating the flow of the wireless output control process. The wireless output control process of the present embodiment is a process of controlling the wireless output power level of the wireless LAN control circuit 174 in the case where the wireless communication device 10 performs wireless communication with the station STA1 in the wireless LAN via the wireless LAN control circuit 174 (refer to FIG. 5).

In step S110 of the wireless output control process, the determination section 122 (FIG. 4) determines whether the main body 100 is connected to the cradle 200 and supplied with power from the cradle 200. When the result of determination in step S110 is that the main body 100 is connected to the cradle 200 and supplied with power from the cradle 200 (YES in step S110), the determination section 122 further determines whether the LAN cable is inserted in the LAN port 220 of the cradle 200 and the LAN port 220 is linked up (step S120). The LAN port 220 being linked up means that the LAN cable is connected to the LAN port 220, and a link is established between the LAN port 220 and a destination station or modem via the LAN cable. In step S120, it is determined whether the wireless communication device 10 is ready for data transfer via the LAN port 220. When the result of determination in step S120 is that the LAN port 220 is linked up (YES in step S120), the determination section 122 determines whether the port selector switch 230 is switched to the “Internet” state (step S130).

When the result of determination in step S130 is that the port selector switch 230 is switched to the “Internet” state (YES in step S130), it means that, as shown in (a) of FIG. 5, the wireless communication device 10 is connected to the modem for the Internet by the wired LAN and is connected to the station STA1 by the wireless LAN. In this case, the wireless output control section 123 (FIG. 4) controls the power supplied to the wireless LAN control circuit 174 to set the output power level of the wireless LAN control circuit 174 to a predetermined standard power level value (step S140).

On the other hand, when the result of determination in any of steps S110, S120, and S130 is “NO”, it means that the wireless communication device 10 is in any of the following states: the main body 100 not being connected to the cradle 200 and therefore not supplied with power from the cradle 200; the main body 100 being connected to the cradle 200 but the LAN cable not being connected to the LAN port 220 of the cradle 200; and a link with the destination equipment not being established or the port selector switch 230 being in the “LAN” state although the LAN cable is connected to the LAN port 220. That is, in this case, the wireless communication device 10 is not in the state where, as shown in (a) of FIG. 5, it is connected to the modem for the Internet by the wired LAN and is connected to the station STA1 by the wireless LAN, but in the state where, as shown in (b) or (c) of FIG. 5, it is connected to the public wireless LAN for the Internet or the mobile communication base station for the Internet by the wireless LAN and is connected to the station STA 1 by the wireless LAN. In this case, the wireless output power level determination section 124 (FIG. 4) determines a low power level value to be used as the wireless output of the wireless LAN control circuit 174 (step S150). Specifically, the wireless output power level determination section 124 determines the low power level value of the wireless output to a predetermined value stored in the ROM 171. This low power level value is smaller than the above-described standard power level value, but is sufficient to maintain wireless communication. After determination of the low power level value to be used as the wireless output, the wireless output control section 123 reduces the power supplied to the wireless LAN control circuit 174 to a power level lower than the power corresponding to the standard power level value, and sets the output power level of the wireless LAN control circuit 174 to the determined low power level value (step S160).

Generally, in the home and office, a modem for the Internet is fixedly installed. Therefore, when the wireless communication device 10 is, as shown in (a) of FIG. 5, connected to the modem for the Internet by the wired LAN and to the station STA 1 by the wireless LAN, the distance between the wireless communication device 10 and the station STA1 tends to increase. On the other hand, when the wireless communication device 10 is, as shown in (b) or (c) of FIG. 5, connected to the public wireless LAN for the Internet or the mobile communication base station for the Internet by the wireless LAN and is connected to the station STA1 by the wireless LAN, the degree of freedom in positioning the wireless communication device 10 is relatively high and, therefore, the distance between the wireless communication device 10 and the station STA1 tends to decrease. In the wireless output control process of the present embodiment, when it is determined that the wireless communication device 10 is, as shown in (a) of FIG. 5, connected to the modem for the Internet by the wired LAN and to the station STA1 by the wireless LAN, the output power level of the wireless LAN control circuit 174 is set at the standard power level value to stabilize the communication. On the other hand, when it is determined that the wireless communication device 10 is, as shown in (b) or (c) of FIG. 5, connected to the public wireless LAN for the Internet or the mobile communication base station for the Internet by the wireless LAN and to the station STA1 by the wireless LAN, the output power level of the wireless LAN control circuit 174 is set at a low power level value smaller than the standard power level value, thereby reducing power consumption, and prolonging the life of the battery 162 of the main body 100. Thus, the wireless communication device 10 can realize stable communication with the station STAT, reduced power consumption, and prolonged battery life, thereby enhancing the user's convenience.

(Modification 1)

The configuration of the wireless communication device 10 according to Embodiment 1 is merely an example, and can be modified in various ways. For example, in Embodiment 1, the cradle connection interface 180 of the main body 100 and the main body connection interface 280 of the cradle 200 perform data communication based on the USB standard. However, the data communication between the main body 100 and the cradle 200 may be performed based on any other standard than the USB standard. In this case, the main body 100 may be provided with an interface compliant with the other standard, instead of the USB host interface 173. The main body 100 does not necessarily include the display section 140.

(Modification 2)

In Embodiment 1, the cradle 200 may be configured so as not to include the LAN port 220, the LAN control circuit 210, or the port selector switch 230. If the cradle 200 does not include the LAN port 220, only the determination as to whether the main body 100 is connected to the cradle 200 (step S110) may be performed in the wireless output control process (FIG. 7), while steps S120 and S130 are skipped. In this case, the connection mode including the wired communication, which is shown in (a) of FIG. 5 and FIG. 6, is not considered. When the result of determination is that the main body 100 is connected to the cradle 200 and supplied with power from the cradle 200 (YES in step S110), the wireless output power level of the wireless LAN control circuit 174 is set at the standard power level value. When the result of determination is that the main body 100 is not connected to the cradle 200 (NO in step S110), the wireless output power level of the wireless LAN control circuit 174 is set at the low power level value. Therefore, when the main body 100 is connected to the cradle 200, stabilized communication is achieved without lowering the wireless output power level. When the main body 100 is not connected to the cradle 200, the life of the battery 162 is prolonged by lowering the wireless output power level.

(Modification 3)

In Embodiment 1, the wireless LAN control circuit 174 or the wireless WAN control circuit 175 may perform wireless communication compliant with a suitable wireless LAN standard that will be available in the future, instead of performing wireless communication compliant with the IEEE 802.11(a/b/g/n) standard. The mobile communication control circuit 176 may perform wireless communication compliant with mobile communication standards that will be available in the future, such as LTE, next-generation mobile WiMAX (IEEE 802.16m), and next-generation PHS (XGP: eXtended Global Platform), instead of performing mobile communication compliant with the 3G/HSPA standard.

(Modification 4)

In Embodiment 1, the wireless LAN control circuit 174, the wireless WAN control circuit 175, and the mobile communication control circuit 176 provide three kinds of wireless communication interfaces. However, the main body 100 may include one or two of these interfaces. Alternatively, the main body 100 may include four or more kinds of wireless communication interfaces. Still further, the main body 100 may include a plurality of wireless communication interfaces of the same kind.

In the wireless output control process, the wireless output power level of either or both of the wireless WAN control circuit 175 and the mobile communication control circuit 176 may be similarly set, instead of the wireless output power level of the wireless LAN control circuit 174, or as well as the wireless output power level of the wireless LAN control circuit 174. The standard power level values of the respective wireless output power levels may be different from each other, or only the low power level values of the respective wireless output power levels may be different from each other. Also in this wireless output control process, it is possible to realize reduced power consumption and prolonged life of the battery 162 while maintaining communication by the wireless communication device 10.

### Embodiment 2

In the wireless output control process according to Embodiment 1 (FIG. 7), if the result of determination in any of steps S110, S120, and S130 is “NO”, the wireless output power level determination section 124 determines, in step S150, the low power level value to be used as the wireless output of the wireless LAN control circuit 174 to a predetermined value. In Embodiment 2, however, in step S150, the wireless output power level determination section 124 detects the input power level of the wireless communication in the wireless LAN control circuit 174, and determines a low power level value to be used as the wireless output, in accordance with the relationship between the predetermined input power level value and the low power level value, so that the greater the detected input power level is, the smaller the low power level value is. The greater the input power level of the wireless communication in the wireless LAN control circuit 174 is, the shorter the distance between the wireless communication device 10 and the station STAT is, and thus stable communication is achieved even if the wireless output power level is low. Accordingly, by configuring the wireless LAN control circuit 174 such that the lower power level value to be used as the output power level of the wireless LAN control circuit 174 is reduced with an increase in the input power level thereof, the output power level of the wireless LAN control circuit 174 can be set at a more appropriate value in accordance with the distance between the wireless communication device 10 and the station STA1. Thus, reduced power consumption and prolonged life of the battery 162 can be effectively realized while maintaining stable communication between the wireless communication device 10 and the station STA1.

In the wireless output control process, the wireless output power level of the wireless WAN control circuit 175 may be similarly set in accordance with the wireless input power level of the wireless WAN control circuit 175, or the wireless output power level of the mobile communication control circuit 176 may be similarly set in accordance with the wireless input power level of the mobile communication control circuit 176, instead of, or as well as, setting the wireless output power level of the wireless LAN control circuit 174 in accordance with the wireless input power level of the wireless LAN control circuit 174. Also in this case, reduced power consumption and prolonged life of the battery 162 can be realized while maintaining communication by the wireless communication device 10.

The present invention is applicable not only to wireless communication devices used in wireless LANs and mobile communications but also to general wireless communication devices used in communication networks including wireless communication networks.

In the above-described embodiments, the CPU 120 loads, into the RAM 172, firmware and computer programs stored in the ROM 171 and executes the firmware and computer programs to control the respective components of the wireless communication device 10. The respective components of the present invention may be implemented by hardware, or alternatively, by software. When part or all of the functions of the present invention are implemented by software, the software (computer program) may be provided in such a manner that it is stored in computer-readable recording media. In the present invention, the “computer-readable recording media” are not limited to portable recording media such as flexible disks and CD-ROMs but include internal storage units in computers, such as RAMs and ROMs, and external storage units fixed to computers, such as hard disks.

While the invention has been described in detail, the foregoing description is in all aspects illustrative and not restrictive. It will be understood that numerous other modifications and variations can be devised without departing from the scope of the invention.

What is claimed is:

1. A wireless communication device for use in a communication network, comprising:
a main body; and
an accessory device connectable to the main body, wherein
the accessory device includes:
a power supply interface configured to supply power to the main body when the accessory device is connected to the main body, and
the main body includes:
one or more wireless communication interfaces configured to perform wireless communication;
a secondary battery for supplying power to the main body at least when the main body is not connected to the accessory device;
a determination section configured to determine whether a predetermined condition is satisfied, the predetermined condition including at least that the main body is connected to the accessory device and supplied with power from the accessory device;
a wireless output power level determination section configured to determine one or more low power level values to be used as the respective wireless output power levels of the one or more wireless communication interfaces; and
a wireless output control section configured to set the wireless output power levels of the one or more wireless communication interfaces to predetermined standard power level values when the predetermined condition is satisfied, and set the wireless output power levels of the one or more wireless communication interfaces to the respective one or more low power level values determined by the wireless output power level determination section, which low power level values are smaller than the predetermined standard power level values, when the predetermined condition is not satisfied.

2. The wireless communication device according to claim 1, wherein
the accessory device further includes:
a port for connecting the accessory device to a network cable; and
a selector switch configured to switch the port between a state where the port functions as a port for the Internet and a state where the port functions as a port for a local network, and wherein
the predetermined condition includes that the port is in the state where it functions as a port for the Internet, and data transfer is carried out via the port.

3. The wireless communication device according to claim 1, wherein
the accessory device further includes:
a port for connecting the accessory device to a network cable; and
a selector switch configured to switch the port between a state where the port functions as a port for the Internet and a state where the port functions as a port for a local network, and wherein
the predetermined condition includes that the port is in the state where it functions as a port for the Internet, and a network cable is connected to the port so that a link is established between the port and a destination device via the network cable.

4. The wireless communication device according to claim 1, wherein
the wireless output power level determination section is configured to determine, for each of at least one wireless communication interface of the one or more wireless communication interfaces, the one or more low power level values in such a manner that the greater the wireless input power level of the wireless communication interface is, the smaller is the low power level value to be used as the wireless output power level of the wireless communication interface.

5. The wireless communication device according to claim 1, wherein
the main body includes a plurality of the wireless communication interfaces performing wireless communications in different wireless communication networks.

6. A wireless communication device for use in a communication network, comprising:
one or more wireless communication interfaces for use in a communication network;
a secondary battery for supplying the wireless communication device with power at least when the wireless communication device is not supplied with power from outside;
a determination section configured to determine whether a predetermined condition is satisfied, the predetermined condition including at least that the main body is supplied with power from outside;
a wireless output power level determination section configured to determine one or more low power level values to be used as the respective wireless output power levels of the one or more wireless communication interfaces; and
a wireless output control section configured to set the wireless output power levels of the one or more wireless communication interfaces to predetermined standard power level values when the predetermined condition is satisfied, and set the wireless output power levels of the one or more wireless communication interfaces to the respective one or more low power level values determined by the wireless output power level determination section, which low power level values are smaller than the predetermined standard power level values, when the predetermined condition is not satisfied.

7. For a wireless communication device used in a communication network and including a processor, a secondary battery, and one or more wireless communication interfaces performing wireless communication, a control method comprising the steps of:
causing the processor to supply the wireless communication device with power from the secondary battery when the wireless communication device is not supplied with power from outside;
causing the processor to determine whether a predetermined condition is satisfied, the predetermined condition including at least that the wireless communication device is supplied with power from outside; and
causing the processor to set wireless output power levels of at least one of the one or more wireless communication interfaces to predetermined standard power level values when the predetermined condition is satisfied, and set the wireless output power levels of the one or more wireless communication interfaces to low power level values, which are smaller than the predetermined standard power level values, when the predetermined condition is not satisfied.
